(19) United States
(12) Patent Application Publication
(10) Pub. No.: US 2010/0190141 A1
(43) Pub. Date: Jul. 29, 2010

(54) LANGUAGE LEARNING

(76) Inventor: John Julius Back, London (GB)

Correspondence Address: EDWIN D. SCHINDLER, FIVE HIRSCH AVENUE, P.O. BOX 966, CORAM, NY, 11727-0966, US

(21) Appl. No.: 12/362,127

(22) Filed: Jan. 29, 2009

(51) Int. Cl. G09B 19/06; G06F 17/28

(52) U.S. Cl. 434/157; 704/2

(57) ABSTRACT

A language teaching aid includes a phrase or sentence in a first language and, adjacent each word in the phrase or sentence, an exact translation into a second language of that word in the context used in the phrase or sentence. Adjacent the exact translation of one or more juxtaposed words, but fewer than all the words of the phrase or sentence, there is a further translation into the second language to render that word or those words more easily understood by the learner. The language teaching aid may be in the form of a book with sentences which together form a story.

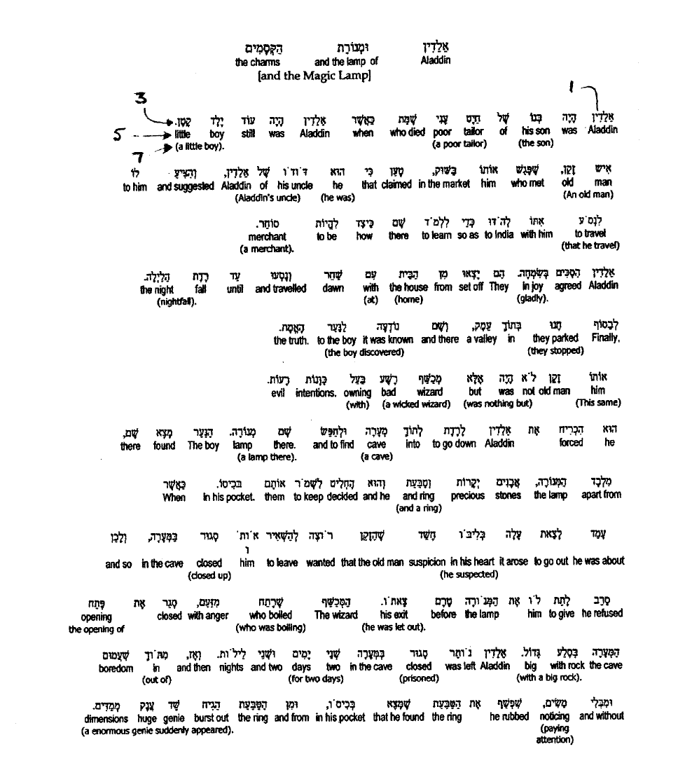

### BACKGROUND OF THE INVENTION

1. Technical Field of the Invention

The present invention relates to foreign language teaching or learning, as well as to translation aids and methods of teaching or learning.

2. Description of the Prior Art

Language teaching aids are known in which phrases or sentences in the language to be learned are translated into the mother language according to the normal rules of syntax and grammar of the mother language. This relationship between the language to be learned and the mother language is often not clear and this can make it very difficult to learn the foreign language.

U.S. Pat. No. 5,275,569 discloses a language teaching aid in which a phrase or sentence is presented in a first language according to its normal rules of syntax and grammar. A word for word translation of the word or phrase into the second language is provided. The second language is then provided in a translation according to the normal rules of syntax and grammar of the second language. Finally, a word for word translation is provided in the first language but from the third presentation in the second language (that which is according to the normal rules of syntax and grammar of the second language.) The differences between the first and fourth presentations are denoted and the differences between the second and the third presentations are denoted.

While this teaching aid provides much information as to the comparisons and differences between the two languages, it does not in itself provide an effective teaching aid. The system is complicated and does not appeal to an individual trying to learn a foreign language to a particular standard, and perhaps in a particular field, in the shortest possible time.

### SUMMARY OF THE INVENTION

According to the present invention, there is provided a language teaching aid comprising:
a phrase or sentence in a first language;
adjacent each word in the phrase or sentence, an exact translation into a second language of that word in the context used in the phrase or sentence; and,
adjacent the exact translation of one or more juxtaposed words, but fewer than all the words of the phrase or sentence, a further translation into the second language to render that word or those words more easily understood by the learner.

The translation aid may be presented in the form of a sheet of paper including a plurality of phrases and/or sentences in said first language.

Preferably, the text being learned includes a plurality of phrases or sentences which together form one or more stories or other pieces of continuous text.

The translation aid may be in the form of a book.

The translation aid of the present invention may be in the form of software for directing a programmable computer to generate said first and second language material, and for displaying the generated material on a computer screen or as a print-out.

A translation aid of the invention may include audio means, such as a CD, which includes a recording of the first language read at a pace suitable to the level of the learner. The audio means, whether provided on the same item (such as a disk) or on a separate item (such as a disk), may include the first language text read at a pace at which the native of that language would normally speak.

The present invention also provides a method of teaching a language comprising:
providing a phrase or sentence in a first language;
providing adjacent each word in the phrase or sentence, an exact translation into the second language of that word in the context used in the phrase or sentence; and
providing adjacent the exact translation of one or more juxtaposed words, but fewer than all the words of the phrase or sentence, a further translation into the second language to render that word or those words more easily understood by the learner.

Additionally, the present invention provides a method of learning a language using a teaching aid of the invention comprising reading the phrase or sentence in the first language in conjunction with the exact translations of the words as well as, when appropriate, further translations.

The present invention is applicable to any language to be learned (first language) and any mother language with which the learner has familiarity (second language.) Typically, the second language will be the learner's mother language. An example of a language to be learned is Hebrew which is read from right to left, but other languages may be read from left to right or up and down.

Other objects and features of the present invention will become apparent when considered in combination with the accompanying drawing figure which illustrates certain preferred embodiments of the present invention. It should, however, be noted that the accompanying drawing figure is intended to illustrate only certain embodiments of the claimed invention and are not intended as a means for defining the limits and scope of the invention.

### BRIEF DESCRIPTION OF THE DRAWING FIGURE

The accompanying drawing is an example of a teaching aid of the present invention in which the first language is Hebrew and the second language is English.

### DETAILED DESCRIPTION OF THE DRAWING FIGURE AND PREFERRED EMBODIMENTS

The present invention will now be described, by way of example only, with reference to the accompanying drawing.

The present invention makes use of a natural, enjoyable and interesting way of learning a new language much akin to a child learning to speak, but replacing the seeing of an object to be identified by the seeing of a word for the object, in one's mother tongue. All other words, not generally identifiable by objects, are learned in a similar manner.

The present invention enables the learner of a foreign language to think in that language when using it, by seeing the structure and order of the words and sentences used.

This may be aided by the learner listening to a CD, which can be downloaded to an MP3 player. A native of the foreign language is reading the text at a pace suitable to the level of the learner. The CD may also provide, or a separate disk may be provided, in which the whole passage or book is read at a pace at which the native of that language would normally speak.

As illustrated in the accompanying drawing, a word 1 of phrase or sentence 3 in Hebrew has printed underneath the exact translation (or transliteration) 5 of that word in the learner's mother tongue (in this case English.) The exact translation is one which is in the context used in that sentence, even where the word may have a different translation in another context. Accordingly, it may be translated differently when the foreign language word appears in other phrases or sentences in the same or a different book.

Inevitably, some words, or groups of words, will not be easily understood if translated exactly into the mother language. For this reason a third line 7 includes a translation into the mother tongue in a manner which makes the particular word, or group of words, more readily understandable. As a result, not all words are translated on the third line but only those which require it for the purpose of understanding. Accordingly, it is not intended to translate the whole phrase or sentence into the mother tongue but only that word, or those words, which really require it to render them more understandable.

It is an established principle that a mind can take in, at the same time, two or three lines, particularly where set out in a clear manner.

It is of particular importance that the text being translated is presented in the form of a story. This enables the learning to move immediately to the advanced stage rather than through the slow process involving learning of isolated vocabulary and grammar. Presentation of the text in the form of a story maintains the learner's interest.

A book in accordance with the present invention may consist of scenarios, stories and existing published works, from fairy tales to adult novels, subject to the necessary copyright licences being obtained.

In addition to general language learning, religious books are suitable subject matter to benefit from the present invention. Many religious works are chanted or sung aloud and a common complaint is that the meaning of the text is not at all clear. Translation in accordance with the present invention would enable the congregant to have a much greater understanding of the text in public prayer.

A repeated reading of the work teaches, by visual and audio memory association, the vocabulary and structure to the reader, without the need for memorizing lengthy lists of vocabulary or rules of grammar.

The learner will pick up the correct pronunciation from the CD and should, in a relatively short period of time, begin to understand and speak the language at any desired level.

The emphasis is on understanding each word in its meaning within the context within which it is used and, in so doing, beginning to think in the language being learned. Any additional translation is inserted to ensure that there can be no misunderstanding of the vocabulary used.

The only prior requirement, in learning a language in accordance with the method of the present invention, is to know the alphabet of the language being learned. Because the whole method is aided by the hearing of the word in the language in which it is written, the learner will, through sight and sound, grasp the thinking of the language being learned.

While only several embodiments of the present invention have been shown and described, it will be obvious to those skilled in the art that many modifications may be made to the present invention without departing from the spirit and scope thereof.

1. A language teaching aid, comprising:
a substrate;
software for directing a programmable computer to generate learning material for a first language and learning material for a second language material, and for displaying the learning material for the first language and the learning material for the second language on said substrate;
a phrase or sentence in the first language generated by said programmable computer, as directed by said software, on said substrate;
adjacent each word in the phrase or sentence generated by said programmable computer, as directed by said software, on said substrate, an exact translation into the second language of that word in the context used in the phrase or sentence; and,
adjacent the exact translation of one or more juxtaposed words, but fewer than all the words of the phrase or sentence, a further translation into the second language for rendering that word, or those words, generated by said programmable computer, as directed by said software, on said substrate and more easily understood by a learner.

2. The language teaching aid according to claim 1, further comprising a plurality of phrases or sentences upon said substrate which together form one or more stories or pieces of continuous text.

3. The language teaching aid according to claim 1, wherein said substrate is a sheet of paper which includes a plurality of phrases or sentences in said first language.

4. The language teaching aid according to claim 3, wherein a plurality of sheets of said sheet of paper form a book.

5. The language teaching aid according to claim 1, wherein said substrate comprises audio means wherein the phrase or sentence is read for a person learning a foreign language.

6. The language teaching aid according to claim 5, wherein said audio means further includes the reading of the phrase or sentence at a pace that is normal for the foreign language.

7. The language teaching aid according to claim 1, wherein said substrate is a computer screen or a computer print-out.

8. A method of teaching a language, comprising the steps of:
directing a programmable computer to generate a phrase or sentence in a first language on a substrate;
directing the programmable computer to generate, adjacent each word in the phrase or sentence on the substrate, an exact translation into a second language of that word in the context used in the phrase or sentence; and,
directing the programmable computer to generate the exact translation of one or more juxtaposed words, but fewer than all the words of the phrase or sentence, a further translation into the second language to render that word or those words on the substrate more easily understood by the learner.

9. (canceled)

10. The method of teaching a language according to claim 8, wherein said substrate is a computer screen or a computer print-out.
